(19) United States
(12) Patent Application Publication
(10) Pub. No.: US 2007/0062608 A1
(43) Pub. Date: Mar. 22, 2007

(54) Maneuvering device for controlled tilting of a cut up trunk portion

(76) Inventor: Joseph Clochard, Thiviers (FR)

Correspondence Address: YOUNG & THOMPSON, 745 SOUTH 23RD STREET, 2ND FLOOR, ARLINGTON, VA, 22202, US

(21) Appl. No.: 10/577,523

(22) PCT Filed: Oct. 30, 2003
(86) PCT No.: PCT/FR03/50110

§ 371 Date: Jun. 29, 2006

(30) Foreign Application Priority Data
Oct. 31, 2002 (FR) 02/13713

(51) Int. Cl. A01G 23/08

(52) U.S. Cl. 144/34.2

(57) ABSTRACT

A maneuvering device for controlled tilting of a cut up trunk portion, having at least one slot (44), characterized in that it includes a body (10) provided with a thread (18), a head (12) mobile in rotation relative to the body (10) and elements (16) for driving the body (10) by the head (12).

The present invention relates to an operating device for the controlled swinging of a portion of a cut tree trunk.

There exist pods disposed on a truck or a trailer permitting raising an operator to the top of trees on which he will work for pruning or felling.

Such mechanical units on a vehicle or a trailer have the drawback of being of a high price whether to purchase or to rent, which prevents their use for short term work.

Moreover, very often such units are not suitable to be disposed at the foot of the tree to be worked on, either because the available space is reduced, or because the ground does not permit the installation of such vehicles.

These reasons lead operators who maintain parks and gardens to act directly on the trees by climbing them and carrying out the work on the tree.

Materials permit ensuring the safety of the operator who has a harness from which are suspended the necessary tools and a safety tether for holding him at the workstation.

These tools are fairly reduced in number and can be a manual saw to trim the branches of small diameter and a power saw for the branches of larger diameter and the tree trunk.

In the case of topping or complete felling, the operator has to climb the tree to cut first of all the major branches. These branches are cut flush with the tree trunk by means of the power saw and fall to the ground, substantially in line with their position.

As to the tree trunk, the operation may not be performed in a forest or in natural surroundings, but in an inhabited region encumbered by other plantings, trees and bushes or constructions which must necessarily be protected.

The operator is thus suspended from the tree trunk to cut it starting from the top into sections of a given height of the order of 1.5 meter to give an idea of the size.

Each section must be cut off on the one hand and sent in a given direction so as to control its falling onto the intended region.

This is generally achieved by means of a rope tied to the precut section and an assistant pulls on the rope.

The problem is to provide an assistant solely for these operations. On the one hand, there is the cost because there is more waiting time than real work, and on the other hand this necessarily complicates the operation because there is an additional person.

As to the operator attached to the tree trunk which he is cutting, he cannot exert force on the precut piece of wood to the extent of being able to lower it especially if it is a trunk having a sufficiently great diameter.

It is possible to provide a lever, but such a tool is poorly adapted. Thus, the lever permits with difficulty controlling the force and it is necessary in any case to exert a strong force. It will be noted that a tool of substantial length is needed to decrease the force necessary, but this is then prejudicial to the size and economy of movement of the operator as well as his safety.

Another drawback of such a tool is the possibility of wedging it beneath the wood section without being able to withdraw it, thus complicating the operation.

Also, the device according to the present invention is particularly suitable and permits overcoming the problems of the prior art by providing operators with means to work alone, and not to complicate their operation, and to adjust the force exerted. Moreover, this device permits performing an inclination with a very great lifting force without requiring great effort on the part of the operator. Moreover, the device permits exerting the forces very progressively, in a completely controlled manner.

Similarly, in the case of wedging or bad positioning, the device can be withdrawn in a sensitive manner, without shock, without more effort than for its introduction. The device according to the invention is very compact, which does not hinder the movements of the operator in the tree.

The device is quite light in weight, which permits hooking it to the harness. It is known also that the sectioner can block and wedge itself beneath the section that is being cut. In this case, the device permits unblocking the sectioner which is a very great advantage. This unblocking takes place without risk and carefully, without danger to the operator from the section that is being cut.

The device according to the present invention will now be described in detail in connection with a particular embodiment, which is non-limiting, with respect to the accompanying drawings, in which the different figures show:

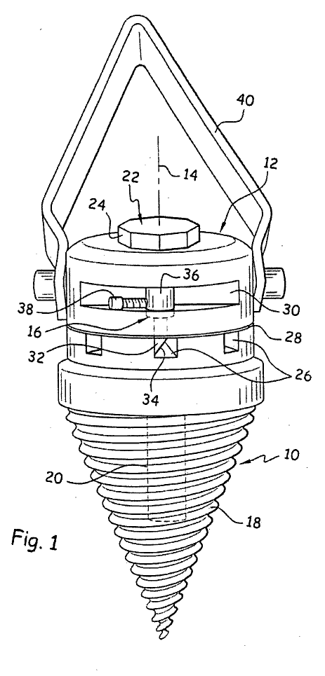

FIG. 1, a perspective view of the device according to the invention, and

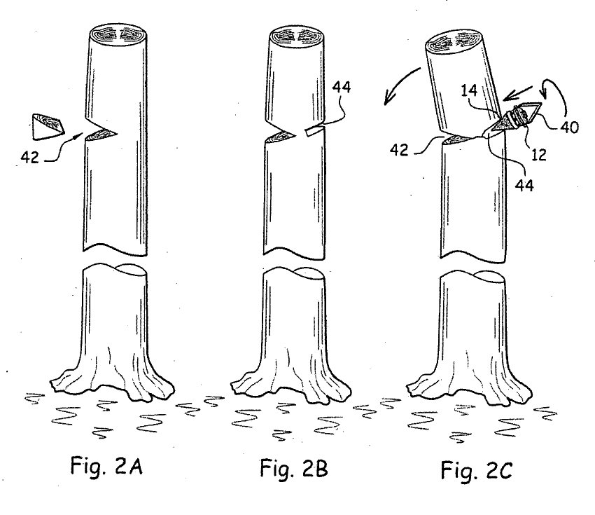

FIGS. 2A to 2C, schematic views showing the use of the device.

The device shown in FIG. 1 comprises a body 10 and a head 12 movable in rotation relative to the body 10, about an axis 14.

The device comprises means 16 for driving between the body 10 and the head 12.

The body 10 is of conical shape and preferably has a screw thread 18. This body is preferably of a polymeric material and is made by molding to permit easy and low cost production.

In the present case, the body also has an internal recess 20 adapted to receive for example a screw 22, disposed along the axis 14. This screw 14 has a head 24, projecting above the upper surface of the head 12 movable in rotation about the axis 14.

This body comprises notches 26, regularly spaced about the periphery in the upper portion, opening onto the interface 28 between the body 10 and the head 12.

The head 12 has a recess 30 in which are disposed the drive means 16. These drive means comprise ratchet 32 oriented parallel to the axis 14. This ratchet 32 comprises a bevel 34 subject to the action of returning, for example a spring. These return means cause the ratchet to project beyond the interface 28 in its outlet drive position, adapted to enter one of the notches 26. The ratchet can also have a second position in which this ratchet is totally withdrawn within the head.

The ratchet 32 is fixed in rotation to a support 36 so as to orient the bevel 34 in one direction or the other, at 180°.

So as to be able to manipulate this support 36 in easy manner, a lever 38 is connected thereto. This lever is accessible within the recess 30.

A gripping and manipulating handle 40 is secured to the head 12, along a diameter.

Thus, the device operates in the following manner, particularly with respect to FIGS. 2A, 2B and 2C.

The operator generally forms a first cut 42 for swinging forming a hinge and a deep slot 44. It is into this deep slot 44 that the body 10 is introduced. This is easy, because the point has a diameter less than that of the slot made by a power saw.

When the point is in the slot, the operator manipulates the handle 40 to turn this head relative to the body. As the ratchet 32 is oriented in the direction in which it blocks itself in one of the notches 26, it drives in rotation the body 10 and ensures screwing of the body into the slot 44. The screwing requires minimum force and the length of the handle permits having a sufficient lever arm to act in complete safety, even up in the air.

Moreover, the polymeric material has a very low coefficient of friction.

Without even releasing the handle 40, the operator turns it in the opposite direction and the ratchet 32 withdraws above each notch thanks to the bevel 34. It is also possible to pivot the handle 40 180° to continue rotation without reversing it.

As shown in FIG. 2C, the body 10 penetrates the slot and widens it because its diameter increases, the outer shape being a cone.

When the section of wood is sufficiently inclined, the swinging takes place sensitively without shock nor suddenly and fall, thus freeing the device. The latter can then be reattached to the belt. There should be noted the small size of this device.

It can happen that the place of introduction of the device selected by the operator will be erroneous or that the first cut 42 will be insufficient. Then the operator must withdraw the device. To this effect, it suffices to manipulate the lever 38 and to pivot it 180°, which orients the bevel 34 in the reverse direction.

The manipulation of the head 12 by the handle 40 ensures unscrewing of the body 10 from the slot, without more effort than for introduction and without risk of untimely falling because the movements are regular and gentle.

This possibility of withdrawal is very important to the activities of all the operators to perform quality work with complete safety.

Similarly, when the power saw is wedged in the course of cutting, the device permits widening the slot in the course of its production to withdraw said power saw before proceeding in total safety.

Numerous variations can be used without changing the spirit of the present invention. Thus, the single ratchet can be multiplied by other ratchets so as to ensure distribution of the forces.

The ratchets can be fixed and the head can be movable in translation with return means for the head against the body to permit unclutching when traction is exerted on handle.

Connection means of the device to the harness can be provided in the form of a flexible connector on a reel so as not to give rise to falling of the device.

1. Operating device for the controlled swinging of a portion of a cut tree trunk, comprising at least one slot (44), characterized in that it comprises a body (10) provided with a screw thread (18), a head (12) movable in rotation relative to the body (10) and means (16) for driving the body (10) by the head (12).

2. Operating device for the controlled swinging of a portion of a cut tree trunk according to claim 1, characterized in that the body (10) is of conical shape.

3. Operating device for the controlled swinging of a portion of a cut tree trunk according to claim 1, characterized in that the drive means (16) comprise notches (26) provided in the body (10) and at least one ratchet (32) adapted to coact with these notches.

4. Operating device for the controlled swinging of a portion of a cut tree trunk according to claim 1, characterized in that each ratchet (32) comprises a bevel (34).

5. Operating device for the controlled swinging of a portion of a cut tree trunk according to claim 4, characterized in that the ratchet (32) is connected in a support (36) disposed in the head (12) and movable between two positions 80° apart so as to be able to orient the bevel (34).

6. Operating device for the controlled swinging of a portion of a cut tree trunk according to claim 5, characterized in that the support (36) comprises a lever (38) for manipulating this support (36).

7. Operating device for the controlled swinging of a portion of a cut tree trunk according to claim 1, characterized in that it comprises a handle (40) for gripping and manipulating secured to the head (12).

8. Operating device for the controlled swinging of a portion of a cut tree trunk according to claim 2, characterized in that the drive means (16) comprise notches (26) provided in the body (10) and at least one ratchet (32) adapted to coact with these notches.
